(19) United States
(12) Patent Application Publication
(10) Pub. No.: US 2026/0099312 A1
(43) Pub. Date: Apr. 9, 2026

(54) SYSTEM AND METHOD FOR CLOUD-BASED AI APPLICATION MANAGEMENT

(71) Applicant: PLUME DESIGN, INC., Palo Alto, CA (US)

(72) Inventors: Miha KLOKOCOVNIK, Ljubljana (SI); Gabrijel JURKOVIC, Ljubljana (SI); Žiga KERŽAN, Domžale (SI); Jaka MAVER, Ljubljana (SI); Rok AJDNIK, Vojnik (SI); Mario BALUKCIC, Jesenice (SI)

(21) Appl. No.: 18/905,194

(22) Filed: Oct. 3, 2024

(51) Int. Cl. G06F 8/65

(52) U.S. Cl. CPC G06F 8/65

(57) ABSTRACT

Disclosed are systems and methods that provide a novel framework for automatically and/or dynamically managing real-time usage and/or implementation of user-based devices, applications and/or accounts in relation to electronic, digital and/or network-based services and/or platforms. The framework operates to provide innovative mechanisms for cloud-based software deployment and user experience management. The framework leverages artificial intelligence (AI) to create and provide an intuitive, personalized and efficient upgrade process for applications installed and/or executing on user devices. The framework can leverage an AI-driven chatbot to engage with users, trigger application upgrade processes and other computerized mechanisms for user device, application and/or account management.

### FIELD OF THE DISCLOSURE

The present disclosure is related to a user device and/or account management system, and more particularly, to a decision intelligence (DI)-based computerized framework for automatically and/or dynamically managing real-time usage and/or implementation of user-based devices, applications and/or accounts in relation to electronic, digital and/or network-based services and/or platforms.

### SUMMARY OF THE DISCLOSURE

According to some embodiments, the disclosed systems and methods provide an innovative framework for software deployment and user experience management. As discussed herein, the disclosed framework leverages artificial intelligence (AI) to create and provide an intuitive, personalized and efficient upgrade process for applications (or “apps”, used interchangeably) installed and/or executing on user devices (e.g., mobile applications on a user's smart phone, for example).

According to some embodiments, the framework's operation can be configured to function in a covert manner, in that it monitors and dormant within the existing application until activated remotely by cloud signals. Such approach ensures that the upgrade mechanism does not interfere with an applications' normal functioning and/or consume unnecessary resources until it is determined to be needed. Accordingly, in some embodiments, as discussed herein, upon detection by the framework, via the cloud, that the user's app version is outdated, the framework can trigger a secure (e.g., “hidden” in that only the framework has read/write access, for example), thereby initiating the intelligent upgrade process discussed herein.

According to some embodiments, central to the framework's operation is an AI-driven interactive chatbot. According to some embodiments, the disclosed chatbot serves as a conversational, knowledgeable guide for users, encouraging them to upgrade their application and assisting them through each step of the process. For example, the AI's ability to engage users in natural language conversation helps to demystify the upgrade process and alleviate any concerns or hesitations users might have about updating their software.

Accordingly, in some embodiments, as discussed in more detail below, the disclosed framework's operation can provide a personalized approach to how upgrades are suggested, recommended, provided and/or installed on user devices. For example, the AI chatbot curates tailored communications with the user, which can be based on, but not limited to, the current app version, specifics of the user's mobile device, user-specific data stored in the cloud, and the like. By leveraging such information, the framework can offer highly personalized recommendations and instructions, making the upgrade process feel custom-tailored to each individual user.

Furthermore, in some embodiments, the framework's capabilities for highlighting specific improvements that are likely to appeal to individual users can evidence an improved user experience (as well as reduction in wasted network and/or computerized resources). For example, in some embodiments, by analyzing user behavior data, the framework can identify features in a new version that align with a user's preferences and/or usage patterns. For example, if a user frequently engages with a particular feature that has been enhanced in the new version, the framework, via the AI chatbot, can emphasize such improvement, making the upgrade more attractive and relevant to the user.

Accordingly, such personalized approach serves multiple purposes. First, it increases the likelihood of users choosing to upgrade, as they can see clear, personal benefits to doing so. Second, it enhances the user experience by guiding them towards new features they are likely to find valuable, potentially increasing their satisfaction with the app overall.

Moreover, by encouraging more users to upgrade to the latest version, it reduces the number of older app versions that need to be maintained. This consolidation of the user base onto newer versions can lead to substantial savings in engineering resources and maintenance costs. It allows development teams to focus on improving and innovating the latest version of the app, rather than splitting their efforts across multiple legacy versions. Indeed, the framework's ability to guide users through the upgrade process can reduce the burden on customer support teams. By providing clear, personalized instructions and addressing potential concerns proactively, the framework, via the AI chatbot, can resolve many upgrade-related issues without human intervention.

As discussed herein, a chatbot is a software application designed to simulate human conversation through text or voice interactions, leveraging AI technologies, particularly natural language processing (NLP) and machine learning (ML). Such technologies enable chatbots to respond to user inputs in a manner that mimics human communication. Typically integrated into websites, messaging apps, mobile apps, and other digital platforms, chatbots provide automated assistance, support, and engagement.

The core components of a chatbot can include the user interface (UI), NLP, dialogue management, backend integration, AI/ML models and business logic, inter alia. Accordingly, the UI is the medium through which users interact with the chatbot, such as a chat window or a voice interface. Natural Language Processing (NLP) allows the chatbot to interpret human language, involving both language understanding and language generation. Dialogue management manages the flow of the conversation, maintaining context and determining appropriate responses based on user inputs and conversation history. Backend integration connects the chatbot to databases, application program interfaces (APIs), and other backend systems, enabling it to retrieve or update information as needed. AI/ML models enable the chatbot to improve over time by learning from interactions, enhancing its ability to understand user intents and refine responses. Business logic provides a set of rules and algorithms that guide the chatbot's behavior in various scenarios, ensuring it aligns with the specific goals and requirements of the entity, resource and/or organization using it.

Accordingly, chatbots can be AI-powered chatbots that use advanced AI and ML techniques to handle more complex interactions, learning from data and improving their performance over time. For example, in addition to the conversational mechanisms discussed herein, chatbots can be utilized in various applications, such as customer service, virtual assistants, information retrieval, and booking systems, providing users with instant and efficient assistance, and the like.

As discussed herein, implementation of an LLM (and/or any other form of AI/machine learning (ML) model) can form the technical basis for the conversations via a chatbot(s). Some LLMs have, among other features and capabilities, theory of mind, abilities to reason, abilities to make a list of tasks, abilities to plan and react to changes (via reviewing their own previous decisions), abilities to compute based on multiple data sources (and types of data—multimodal), abilities to have conversations with humans in natural language, abilities to adjust, abilities to interact with and/or control application program interfaces (APIs), abilities to remember information long term, abilities to use tools (e.g., read multiple schedules/calendars, command other systems, search for data, and the like), abilities to use other LLM and other types of AI/ML (e.g., neural networks to look for patterns, recognize humans, pets, and the like, for example), abilities to improve itself, abilities to correct mistakes and learn using reflection, and the like.

Thus, as provided herein, the disclosed integration of such LLM technology, as well as known or to be known AI/ML models, to execute the disclosed conversational web, chatbot-based mechanisms discussed herein provide an improved system that can improve how users are capable of interacting with network-hosted content (e.g., receive application upgrades, for example), inter alia.

Accordingly, the disclosed systems and methods have implications for app security and performance. By facilitating more widespread adoption of the latest app versions, the disclosed framework can ensure that more users benefit from the most recent security patches and performance optimizations. This can lead to an overall improvement in the app's security posture and user satisfaction.

According to some embodiments, a method is disclosed for a DI-based computerized framework for automatically and/or dynamically managing real-time usage and/or implementation of user-based devices, applications and/or accounts in relation to electronic, digital and/or network-based services and/or platforms. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for automatically and/or dynamically managing real-time usage and/or implementation of user-based devices, applications and/or accounts in relation to electronic, digital and/or network-based services and/or platforms.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 illustrates an exemplary workflow according to some embodiments of the present disclosure;

FIG. 5 depicts an exemplary implementation of an architecture according to some embodiments of the present disclosure;

FIG. 6 depicts an exemplary implementation of an architecture according to some embodiments of the present disclosure; and

FIG. 7 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

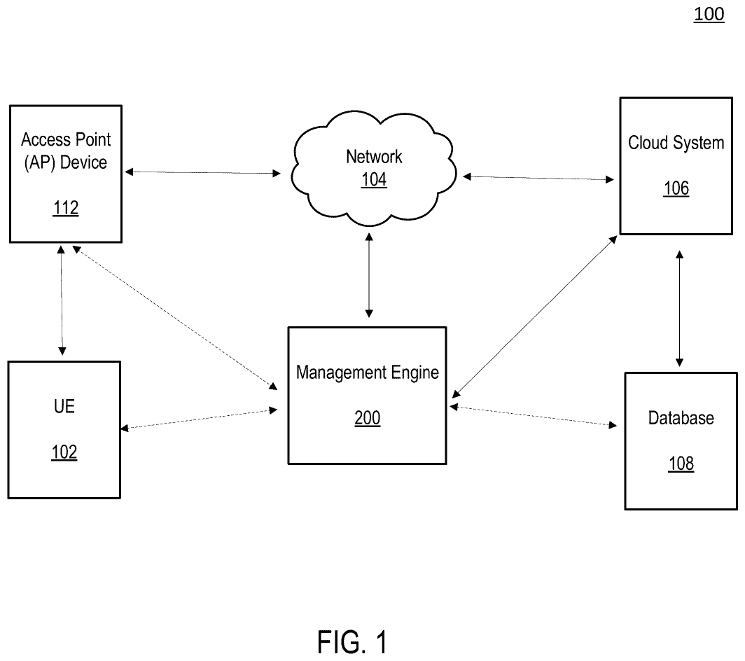

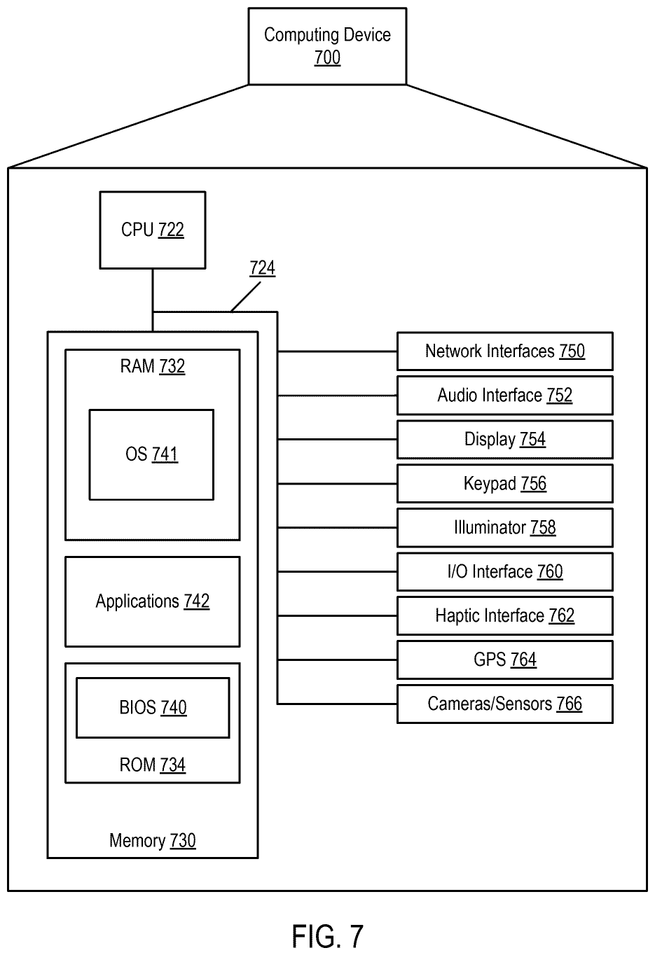

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 7), access point (AP) device 112, network 104, cloud system 106, database 108 and management engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, Internet of Things (IoT) device, wearable device (e.g., smart ring, smart watch, for example), autonomous machine, and any other device equipped with a cellular or wireless or wired transceiver.

In some embodiments, peripheral device (not shown) can be connected to UE 102, and can be any type of peripheral device, such as, but not limited to, a wearable device (e.g., smart ring or smart watch), printer, speaker, sensor, and the like. In some embodiments, peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates a wireless local area network (WLAN) for the location. According to some embodiments, the AP device 112 can be, but is not limited to, a router, switch, hub and/or any other type of network hardware that can project a WiFi signal to a designated area. For example, an AP device 112 can be a Plume Pod™, and the like. In some embodiments, UE 102 may be an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider, which has associated network resources hosted on the internet or private network (e.g., network 104), which enables (via engine 200) the functional management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

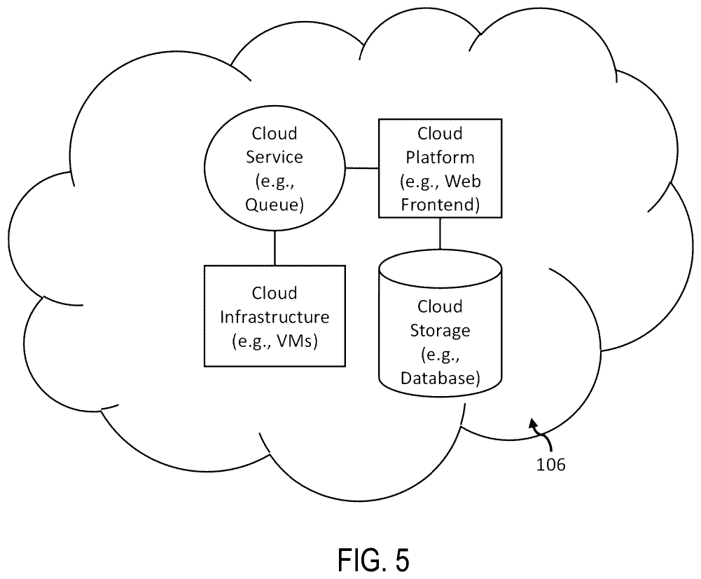

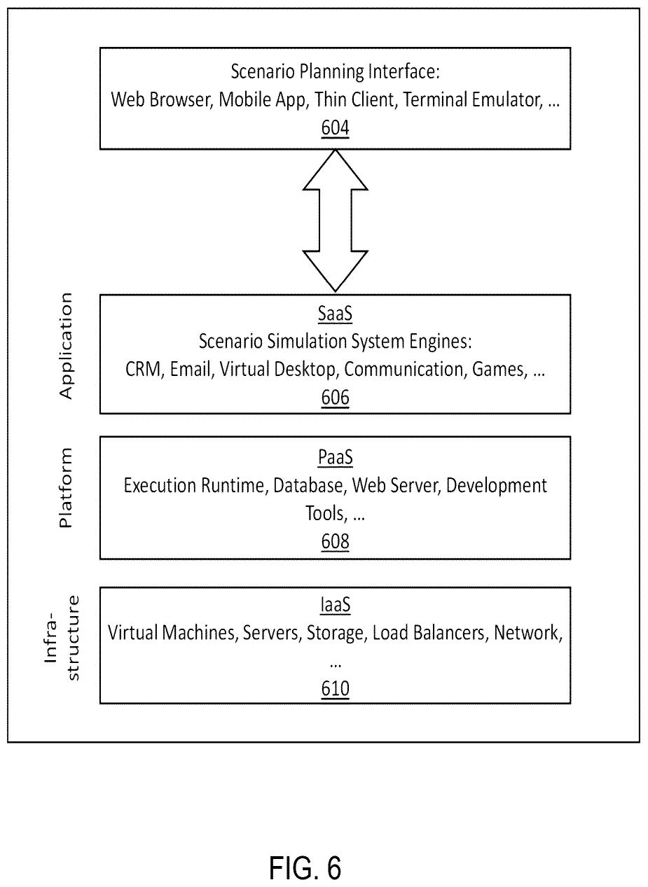

Turning to FIGS. 5 and 6, in some embodiments, the exemplary computer-based systems/platforms, the exemplary computer-based devices, and/or the exemplary computer-based components of the present disclosure may be specifically configured to operate in a cloud computing/architecture 120 such as, but not limiting to: infrastructure as a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository

Management engine 200, as discussed above and further below in more detail, can include components for the disclosed functionality. According to some embodiments, management engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

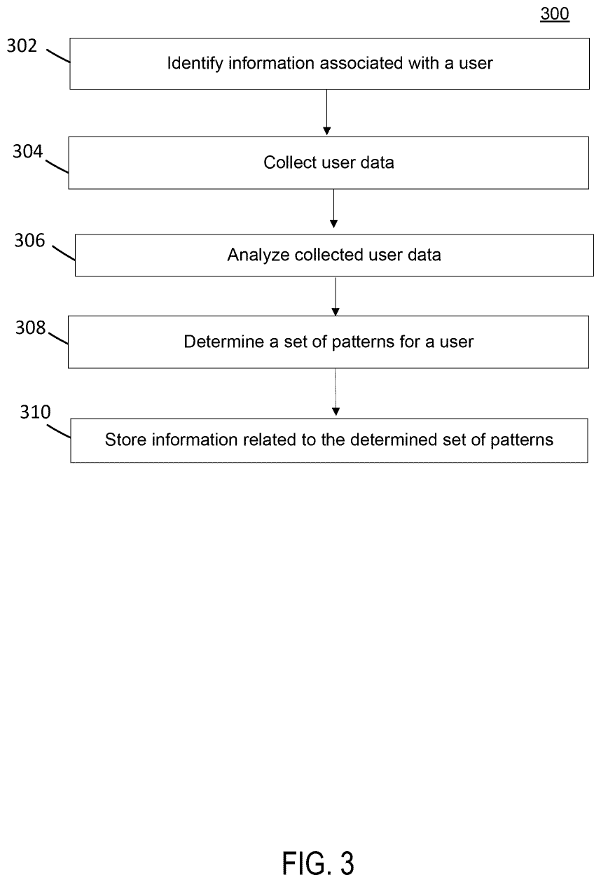

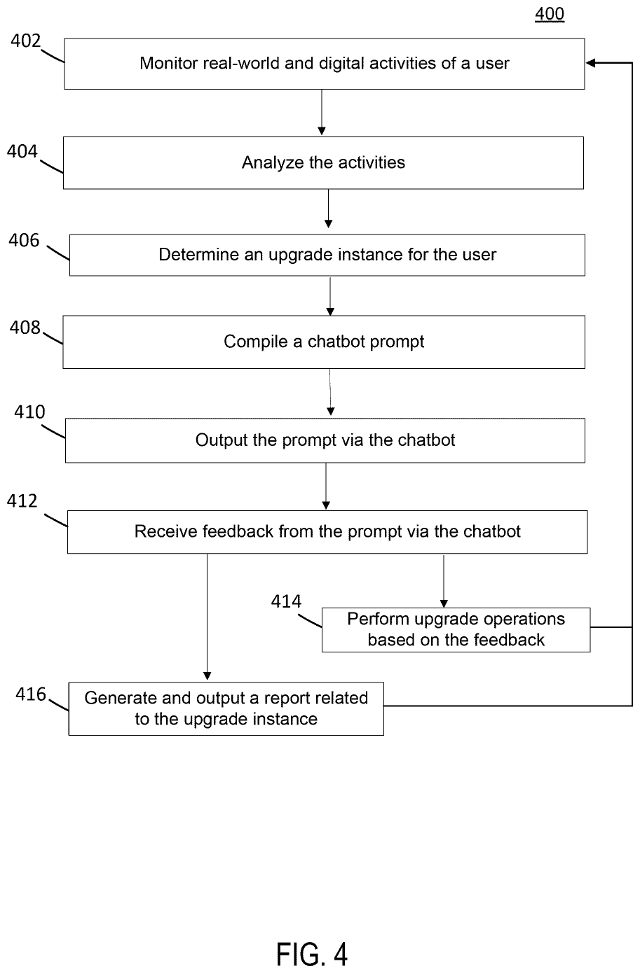

According to some embodiments, as discussed in more detail below, management engine 200 may be configured to implement and/or control a plurality of services and/or microservices, where each of the plurality of services/microservices are configured to execute a plurality of workflows associated with performing the disclosed security management. Non-limiting embodiments of such workflows are provided below in relation to at least FIGS. 3-4.

According to some embodiments, as discussed above, management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102 (and/or AP device 112, in some embodiments). In some embodiments, such application may be a web-based application accessed by AP device 112, UE 102 and/or other devices accessible by and/or associated with network 104 from cloud system 106. In some embodiments, engine 200 may be configured and/or installed as an augmenting script, program or application (e.g., a plug-in or extension) to another application or program provided by cloud system 106 and/or executing on AP device 112 and/or UE 102.

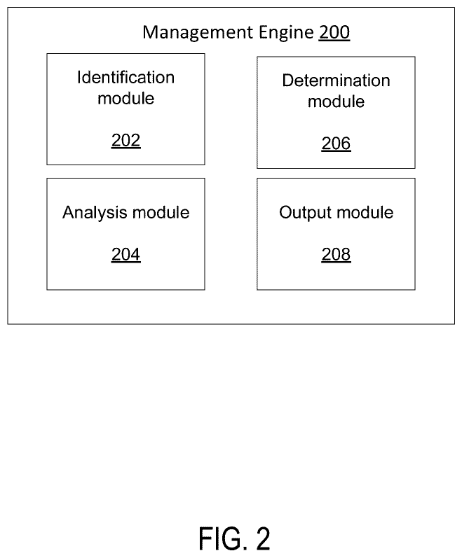

As illustrated in FIG. 2, according to some embodiments, management engine 200 includes identification module 202, analysis module 204, determination module 206 and output module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

Turning to FIGS. 3 and 4, Processes 300 and 400, respectively, provide non-limiting example embodiments for the disclosed (application, user, device and/or account) management framework. According to some embodiments, Process 300 provides non-limiting embodiments for determining a context and/or patterns of activity, inter alia, for a user (and/or device) for which the disclosed framework (e.g., via management engine 200) can control, manage and manipulate the operational status of the application and/or device such application is executing thereon, as provided in Process 400.

According to some embodiments, as discussed herein, the disclosed innovative AI-driven application upgrade framework represents a significant leap forward in software update management, addressing the pervasive issue of user reluctance towards software upgrades. Traditional methods of encouraging users to update their applications, such as static pop-up messages, often fall short, leading to a fragmented user base and increased maintenance costs for developers. The instant framework leverages AI, data analytics and user-centric design to create a more dynamic, personalized, and effective upgrade experience.

According to some embodiments, the disclosed framework's architecture is composed of several interconnected services, each playing a crucial role in the upgrade process, which as provided below in relation to FIGS. 3 and 4, can be embodied in and executed via engine 200.

According to some embodiments, engine 200 can execute an AI context service that gathers and maintains crucial contextual information. Engine 200 can collect user-specific information, current application state (including device OS, app version, and usage statistics), general product data, product release notes, and the desired app version (as set by the product owner or defaulting to the latest version). Such service can interface with existing product services and the App Reporter Service to build a comprehensive user and application profile, which is then fed to other components of the framework to enable personalized user engagement and accurate classification.

In some embodiments, engine 200 can operate an AI classification service, which categorizes users based on their reluctance to upgrade. Such classification can include categories such as, but not limited to, infrequent app users, those fearing loss of familiar functionality, users waiting for increased stability, those outright refusing to upgrade, and the like. Such classification is dynamic, with instructions being received by engine 200 to reclassify users as needed. In some embodiments, such service operations can be utilized by engine 200 to analyze chat data from the cloud AI chatbot service, discussed infra to refine its classifications based on user interactions, ensuring that the framework's understanding of each user's concerns and motivations remains current and accurate.

According to some embodiments, engine 200 can operate an AI chatbot service (e.g., cloud-based chatbot, as discussed herein), which functions to, for example, identify and classify user pain points regarding upgrades, develops persuasive strategies to encourage users to upgrade, and provides step-by-step guidance through the upgrade process. Such service works in close conjunction with the AI context service and AI classification service, using the gathered data to tailor engine 200's approach to each user's specific situation and concerns. By leveraging this wealth of contextual information, the chatbot can engage users in meaningful conversations about the upgrade, addressing their specific concerns and highlighting the benefits most relevant to their usage patterns, as provided below.

In some embodiments, engine 200 can operate an orchestrator service that acts as the central coordinator, managing the overall upgrade process. Engine 200 can determine an optimal time to initiate the upgrade process for specific users, refresh contextual data as needed, maintain the state of each user's upgrade progress, generate reports and visualizations for product owners, and the like, or some combination thereof. Such service ensures a smooth, non-redundant user experience by coordinating the activities of the AI context, AI classification, and cloud AI chatbot services. Moreover, in some embodiments, engine 200's ability to track progress and generate reports provides valuable insights for product owners, enabling data-driven decision-making about app management and future development priorities.

In some embodiments, engine 200 can operate an app reporter service, which can operate/function and/or run/execute on the backend (or background). Such service can function to periodically collect and report app state and usage data to the cloud. This enables the framework to initiate the upgrade process even when the user is not actively using the app, ensuring timely upgrades and maintaining system security. By providing a constant stream of up-to-date information about the app's state and usage patterns, this service plays a crucial role in keeping the AI context service executed by engine 200 informed and allowing for proactive upgrade initiatives.

In FIG. 3, according to some embodiments, Steps 302-304 of Process 300 can be performed by identification module 202 of management engine 200; Step 306 can be performed by analysis module 204; Step 308 can be performed by determination module 204; and Step 310 can be performed by output module 208.

According to some embodiments, Process 300 begins with Step 302 where a set of applications (and/or devices) associated with a user are identified. In some embodiments, the applications can correspond to applications installed on the user's device(s). Such application information can include, but not be limited to, application identifier (ID), app type, app version, supportive OS for the app, installation date, frequency of use, and the like, or some combinations thereof. According to some embodiments, the devices can be associated with any type of UE 102, AP device 112, and the like, discussed above in relation to FIG. 1. Such device information can include, but not be limited to, device ID, device type, device version, OS executing on the device, accounts associated with the device, IMEI (International Mobile Equipment Identity) information, SIM (Subscriber Identity Module) information, SSID (service set identifier) information, and the like, or some combination thereof.

In Step 304, engine 200 can operate to collect data about the user (e.g., referred to as user data). According to some embodiments, the user data can be collected continuously and/or according to a predetermined period of time or interval. In some embodiments, user data may be collected based on detected events. According to some embodiments, the user data correspond to, but not be limited to, a time, duration, date, device ID, application ID, user and/or account ID, type of activity, content, service type/category/provider, frequency of usage, faults/errors with the application, and the like, or some combination thereof.

In some embodiments, the collected user data in Step 304 can be stored in database 108 in association with an ID of the user, an ID of the application and/or an ID of an account of the user/application.

In Step 306, engine 200 can analyze the collected user data. According to some embodiments, engine 200 can implement any type of known or to be known computational analysis technique, algorithm, mechanism or technology to analyze the collected user data from Step 306.

In some embodiments, engine 200 may include a specific trained artificial intelligence/machine learning model (AI/ML), a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and NLP. Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, engine 200 may be configured to identify and utilize one or more AI/ML techniques chosen from, but not limited to, computer vision, feature vector analysis, decision trees, boosting, support-vector machines, neural networks, nearest neighbor algorithms, Naive Bayes, bagging, random forests, logistic regression, and the like. By way of a non-limiting example, engine 200 can implement an XGBoost algorithm for regression and/or classification to analyze the user data, as discussed herein.

According to some embodiments, the AI/ML computational analysis algorithms implemented can be applied and/or executed in a time-based manner, in that collected user data for specific time periods can be allocated to such time periods so as to determine patterns of activity (or non-activity) according to a criteria. For example, engine 200 can execute a Bayesian determination for a predetermined time span, at preset intervals (e.g., a 24 hour time span, every 8 hours, for example), so as to segment the day according to applicable patterns, which can be leveraged to determine, derive, extract or otherwise activities/non-activities in/around usage of an application/device.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly-received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

In Step 308, based on the analysis from Step 306, engine 200 can determine a set of patterns for a user(s) (and/or patterns of use of an application(s) installed on the user's device). According to some embodiments, the determined patterns are based on the computational AI/ML analysis performed via engine 200, as discussed above. Thus, as discussed herein, while the discussion may focus on an application on a user device for a user, it should not be construed as limiting, as one of skill in the art would readily understand that, inter alia, multiple applications on a device of a user, multiple applications on multiple devices of a user, an application on multiple devices of a user, and/or multiple users, can form the basis for the processing in Process 300 (Process 400, discussed infra) without departing from the scope of the instant disclosure.

In some embodiments, the set of patterns can correspond to, but are not limited to, types of events, types of content, inputs, downloads, uploads, types of detected activity, a time of day, a date, type of user, duration, amount of activity, quantity of activities, network/local resources, and the like, or some combination thereof. Accordingly, the patterns can be specific to a user, and/or specific to the application, and can provide a context of usage of the application by the user. Thus, according to some embodiments, Step 308 can involve engine 200 determining a set of application patterns, which as discussed below at least in relation to Process 400 of FIG. 4, can be utilized to generate personalized application upgrade controls for the user.

In Step 310, engine 200 can store the determined set of patterns in database 108, in a similar manner as discussed above. According to some embodiments, Step 310 can involve creating a data structure associated with each determined pattern, whereby each data structure can be stored in a proper storage location associated with an identifier of the user/application, as discussed above.

In some embodiments, a pattern can comprise a set of information, which can correspond to an activity (e.g., scrolling through content, for example). In some embodiments, the pattern's data structure can be configured with header (or metadata) that identifies a user and/or the application, and/or a time period/interval of analysis (as discussed above); and the remaining portion of the structure providing the data of the activity/non-activity and application status during such sequence(s). In some embodiments, the data structure for a pattern can be relational, in that the activities within a pattern can be sequentially ordered, and/or weighted so that the order corresponds to events with more or less activity.

In some embodiments, the structure of the data structure for a pattern can enable a more computationally efficient (e.g., faster) search of the pattern to determine if later detected events correspond to the events of the pattern, as discussed below in relation to at least Process 400 of FIG. 4. In some embodiments, the data structures of patterns can be, but are not limited to, files, arrays, lists, binary, heaps, hashes, tables, trees, and the like, and/or any other type of known or to be known tangible, storable digital asset, item and/or object.

According to some embodiments, the user data can be identified and analyzed in a raw format, whereby upon a determination of the pattern, the data can be compiled into refined data (e.g., a format capable of being stored in and read from database 108). Thus, in some embodiments, Step 310 can involve the creation and/or modification (e.g., transformation) of the user data into a storable format.

In some embodiments, as discussed below, each pattern (and corresponding data structure) can be modified based on further detected behavior, as discussed below in relation to Process 400 of FIG. 4.

Turning to FIG. 4, Process 400 provides non-limiting example embodiments for the deployment and/or implementation of the disclosed application management framework.

According to some embodiments, as discussed herein, the disclosed framework operates in a seamless manner respective to application usage, and designed to be user-centric. As discussed below respective to the steps of Process 400, processing by the framework begins with context gathering (e.g., continuous, for example) by engine 200, via the executed AI context service, collecting and updating user and app information. Based on this data, engine 200, via the executed orchestrator service, determines when to start the upgrade process for specific users. Engine 200, via the AI classification service, can then categorize users based on their reasons for upgrade reluctance. Utilizing the gathered context and classification data, engine 200, via the cloud AI chatbot service can interact with users via the App AI chatbot service, which guides users through the upgrade process via interactive elements displayed within a user interface (UI) on the user's device (as associated with the chatbot). Throughout this process, engine 200, via the orchestrator service, can track progress, maintain upgrade states, and generate reports for product owners.

As provided herein, and discussed above, such AI-driven approach offers numerous benefits for both users and developers. For users, the framework provides a personalized experience that tailors the upgrade process to each individual's specific situation, addressing their unique concerns and hesitations. By explaining the benefits of new features and the reasons for upgrades, users gain a better understanding of why updates are important, reducing anxiety and resistance to change. The step-by-step guidance reduces the perceived complexity of the upgrade process, making users more likely to complete it. Moreover, by encouraging more frequent upgrades, users benefit from the latest security patches and improvements, enhancing their overall app experience and security.

For developers and companies, the framework offers significant advantages in terms of resource optimization and cost savings. By reducing the number of older app versions in use, companies can focus their resources on improving and maintaining fewer versions, leading to more efficient use of engineering resources and reduced maintenance costs. Indeed, with more users on recent versions, managing security becomes more straightforward and effective. Further, the disclosed framework can be configured with technical considerations related to privacy and data security, such that the framework's configuration ensures robust data protection measures are implemented, as they can comply with relevant privacy regulations (e.g., General Data Protection Regulation (GDPR), California Consumer Privacy Act (CCPA), and the like).

According to some embodiments, Step 402 of Process 400 can be performed by identification module 202 of management engine 200; Step 404 can be performed by analysis module 204; Steps 406 and 408 can be performed by determination module 206; and Steps 410-416 can be performed by output module 208.

According to some embodiments, Process 400 begins with Step 402 where engine 200 can monitor the user's device to detect, determine or otherwise identify activity related to application usage. In some embodiments, such usage can correspond to activity of usage and/or non-activity (e.g., the application is closed and/or not currently being used, and/or may be running in the background, for example). In some embodiments, such monitoring can be performed in accordance with, based on and/or in line w/ the patterns of activity or context of the user, as discussed above in relation to Process 300 of FIG. 3.

In some embodiments, engine 200 can monitor the device continuously, and/or according to a predetermined time interval. In some embodiments, the monitoring can involve push and/or fetch protocols to collect user data related to the application (e.g., its current status, usage, and the like).

In Step 404, based on the monitoring in Step 402, engine 200 can analyze the monitored activities (and corresponding collected data based therefrom), which can be performed in a similar manner as discussed above at least in relation to Step 306. In some embodiments, the analysis of the current user data can be based on the patterns of activity, as provided above respective to Process 300 in FIG. 3. Thus, such collected data in Step 404 and a pattern/context can be input into an AI/ML and/or LLM model, as discussed above.

In some embodiments, the collected activity data from Step 402 can be mined and/or parsed for data related to user activity of the application, whereby such user activity data can be extracted and analyzed therefrom.

In Step 406, engine 200 can, based on the analysis from Step 404, determine whether an upgrade instance of the application for the user is required. As discussed above, such determination can involve a classification of the user, and/or be based on indications from the patterns/context that the user used the application, but as per typical given their pattern/context, stopped in relation to a specific feature of the application.

According to some embodiments, Step 406 can further involve engine 200 determining, based on cloud-provided data, that an application version exists that is not currently installed on the user's device that remedies such issue, for example.

Accordingly, Step 406 can involve determining information related to, but not limited to, current activity of the user, application status, application state (e.g., opened, running, and the like), application version, and the like, or some combination thereof.

In Step 408, engine 200 can compile a chatbot prompt. The compilation of the chatbot prompt can involve engine 200 utilizing an LLM (and/or AI/ML, as discussed above), with the information determined from Step 406 (and/or Step 404) as input. For example, in some embodiments, engine 200 can determine that a feature of the application is not a preferred feature of the user, and that a new version of the application provides an improvement to the feature that, upon analysis of the user's patterns/context, indicates the user would use such feature as part of their application usage (as in Step 406). Therefore, in Step 408, engine 200 can input such information to AI/ML and/or LLM models, for which a chatbot prompt can be generated-for example: “Are you having problems with feature X? If you install new version Y, those problems will be fixed.” IN another example, the chatbot can state: “Have you tried new version Y of application Z? There is a new feature that will help you with your work.”

In Step 410, engine 200 can cause the compiled prompt to be output via the chatbot, which as discussed above, can be displayed within a UI on the user's device. In some embodiments, the UI can be displayed as part of a separate chatbot application instance on the user's device; and in some embodiments, the UI can be displayed within and/or in relation to a display of the interface of the application for which the prompt is related. In some embodiments, the provided prompt UI can include an input (e.g., text, audio, images, and the like) entry area for which a response can be provided.

In Step 412, engine 200 can receive feedback from the user device via the UI, as discussed above. For example, the user can enter text stating, “Yes, I would like to download the new application version” or “Provide more information” or “No, I am not interested”.

In some embodiments, if the response, as per an NLP analysis by engine 200 indicates that the feedback declines the upgrade, the LLM and/or AI/ML model associated with the chatbot can further response attempting to persuade the user. In some embodiments, processing can halt, whereby upon further monitoring as in Step 402 at another time (and/or another application instance/usage), will the chatbot reengage the user.

Accordingly, upon the feedback in Step 412 indicating that the upgrade is requested by the user, engine 200 can proceed to Step 414. In some embodiments, a chatbot can guide users through updating or downloading an application by providing clear, sequential instructions tailored to the user's device and operating system.

By way of non-limiting example, for mobile devices, the chatbot can direct users to their device's app store (App Store for iOS or Google Play Store for Android), guiding them to search for the application by name. In some embodiments, the instructions can instruct users to look for an “Update” button if the app is already installed, or a “Download” button if it's a new installation. The chatbot can explain how to check for available storage space and suggest connecting to Wi-Fi for larger downloads.

In another non-limiting example, for desktop applications, the chatbot can provide instructions on how to check for updates within the application itself, or direct users to the software developer's website to download the latest version.

Accordingly, as in Step 414, engine 200's operation of the chatbot can offer troubleshooting tips for common issues, such as slow download speeds or installation errors. In some embodiments, engine 200 can also explain the benefits of keeping the application updated, such as access to new features, improved performance, and security enhancements. The chatbot might conclude by instructing the user on how to launch the updated application and verify that the update was successful. By breaking down the process into manageable steps and providing clear, concise instructions, engine 200, via the chatbot, can interactively guide users through application updates or downloads, ensuring a smooth user experience.

In some embodiments, the upgrade operation in Step 414 can involve engine 200 automatically causing the update/upgrade to the application on the user's device. This can involve compiling the executable instructions for the application upgrade/install being compiled into an electronic message, that upon it being sent to the device of the user, causes execution such that the application is upgraded/installed accordingly.

In Step 416, as discussed above, engine 200 can compile/generate an electronic report related to the upgrade instance. The report can be sent to a content provider, service provider, application provider, the user, an administrator, and the like, and provide information related to, but not limited to, the previous application instance, the upgrade, device ID, application ID, user ID, and the like, and/or any other information related to the upgrade operations discussed herein (as per the information collected and analyzed in Steps 402-404, discussed supra). In some embodiments, the report can include information related to the chatbot interactions with the user, which can indicate the approval to upgrade and/or the denial to upgrade, as discussed above.

In some embodiments, the report can be utilized to further train the models utilized for processing, which as discussed above, can be any of the AI/ML and/or LLMs (e.g., chatbot(s)) discussed supra.

Accordingly, upon completion of the processing of Steps 412 and/or 414, engine 200 can recursively proceed back to Step 402, where monitoring of activities of the user can proceed.

Thus, as discussed herein, the disclosed framework, via engine 200's operation discussed supra, provides an intelligent and user-friendly approach to software updates. The disclosed framework's operation moves beyond the limitations of static upgrade prompts, engaging users in meaningful dialogues about the benefits of upgrading and addressing their specific concerns. This personalized approach not only increases the likelihood of successful upgrades but also enhances the overall user experience, potentially leading to greater user satisfaction and loyalty.

FIG. 7 is a schematic diagram illustrating a client device showing an example embodiment of a client device that may be used within the present disclosure. Client device 700 may include many more or less components than those shown in FIG. 7. However, the components shown are sufficient to disclose an illustrative embodiment for implementing the present disclosure. Client device 700 may represent, for example, UE 102 discussed above at least in relation to FIG. 1.

As shown in the figure, in some embodiments, Client device 700 includes a processing unit (CPU) 722 in communication with a mass memory 730 via a bus 724. Client device 700 also includes a power supply 726, one or more network interfaces 750, an audio interface 752, a display 754, a keypad 756, an illuminator 758, an input/output interface 760, a haptic interface 762, an optional global positioning systems (GPS) receiver 764 and a camera(s) or other optical, thermal or electromagnetic sensors 766. Device 700 can include one camera/sensor 766, or a plurality of cameras/sensors 766, as understood by those of skill in the art. Power supply 726 provides power to Client device 700.

Client device 700 may optionally communicate with a base station (not shown), or directly with another computing device. In some embodiments, network interface 750 is sometimes known as a transceiver, transceiving device, or network interface card (NIC).

Audio interface 752 is arranged to produce and receive audio signals such as the sound of a human voice in some embodiments. Display 754 may be a liquid crystal display (LCD), gas plasma, light emitting diode (LED), or any other type of display used with a computing device. Display 754 may also include a touch sensitive screen arranged to receive input from an object such as a stylus or a digit from a human hand.

Keypad 756 may include any input device arranged to receive input from a user. Illuminator 758 may provide a status indication and/or provide light.

Client device 700 also includes input/output interface 760 for communicating with external. Input/output interface 760 can utilize one or more communication technologies, such as USB, infrared, Bluetooth™, or the like in some embodiments. Haptic interface 762 is arranged to provide tactile feedback to a user of the client device.

Optional GPS transceiver 764 can determine the physical coordinates of Client device 700 on the surface of the Earth, which typically outputs a location as latitude and longitude values. GPS transceiver 764 can also employ other geo-positioning mechanisms, including, but not limited to, triangulation, assisted GPS (AGPS), E-OTD, CI, SAI, ETA, BSS or the like, to further determine the physical location of client device 700 on the surface of the Earth. In one embodiment, however, Client device 700 may through other components, provide other information that may be employed to determine a physical location of the device, including for example, a MAC address, Internet Protocol (IP) address, or the like.

Mass memory 730 includes a RAM 732, a ROM 734, and other storage means. Mass memory 730 illustrates another example of computer storage media for storage of information such as computer readable instructions, data structures, program modules or other data. Mass memory 730 stores a basic input/output system (“BIOS”) 740 for controlling low-level operation of Client device 700. The mass memory also stores an operating system 741 for controlling the operation of Client device 700.

Memory 730 further includes one or more data stores, which can be utilized by Client device 700 to store, among other things, applications 742 and/or other information or data. For example, data stores may be employed to store information that describes various capabilities of Client device 700. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 700.

Applications 742 may include computer executable instructions which, when executed by Client device 700, transmit, receive, and/or otherwise process audio, video, images, and enable telecommunication with a server and/or another user of another client device. Applications 742 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:
Aspect 1. A method comprising:
   identifying an application installed on a user device;
   analyzing activity related to execution of the application by a user;
   determining, based on the analysis, an upgrade instance, the upgrade instance corresponding to the activity of the user;
   communicating, via a user interface (UI) of a chatbot, with the user, the communication corresponding to the upgrade instance; and
   performing the upgrade instance based on the communication with the user via the chatbot.
Aspect 2. The method of aspect 1, further comprising:
   analyzing information related to the upgrade instance;
   compiling a prompt for the chatbot; and
   outputting, via the UI, the prompt.
Aspect 3. The method of aspect 2, further comprising:
   receiving feedback from the user via the UI in response to the prompt;
   analyzing the feedback; and
   determining, based on the analysis of the feedback, whether to perform the upgrade instance.
Aspect 4. The method of aspect 2, further comprising the analysis of the information related to the upgrade instance being performed by a large language model (LLM) associated with the chatbot.
Aspect 5. The method of aspect 1, further comprising the activity related to the execution of the application corresponding to features of the application, the activity related to the usage of the features by the user.
Aspect 6. The method of aspect 1, further comprising the activity related to the execution of the application corresponding to a point of failure related to the usage of the application by the user, the point of failure related to non-used features or abandonment of use of the application by the user.
Aspect 7. The method of aspect 1, further comprising:
   analyzing information associated with the user, the information corresponding to the user, the application and the user device;
   determining a pattern of activity for the user, the pattern of activity related to usage of the application; and
   performing the analysis of the activity related to execution of the application based further on the pattern of activity.
Aspect 8. The method of aspect 1, further comprising the upgrade instance being provided by a Cloud.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying an application installed on a user device;
analyzing activity related to execution of the application by a user;
determining, based on the analysis, an upgrade instance, the upgrade instance corresponding to the activity of the user;
communicating, via a user interface (UI) of a chatbot, with the user, the communication corresponding to the upgrade instance; and
performing the upgrade instance based on the communication with the user via the chatbot.

2. The method of claim 1, further comprising:
analyzing information related to the upgrade instance;
compiling a prompt for the chatbot; and
outputting, via the UI, the prompt.

3. The method of claim 2, further comprising:
receiving feedback from the user via the UI in response to the prompt;
analyzing the feedback; and
determining, based on the analysis of the feedback, whether to perform the upgrade instance.

4. The method of claim 2, further comprising the analysis of the information related to the upgrade instance being performed by a large language model (LLM) associated with the chatbot.

5. The method of claim 1, further comprising the activity related to the execution of the application corresponding to features of the application, the activity related to the usage of the features by the user.

6. The method of claim 1, further comprising the activity related to the execution of the application corresponding to a point of failure related to the usage of the application by the user, the point of failure related to non-used features or abandonment of use of the application by the user.

7. The method of claim 1, further comprising:
analyzing information associated with the user, the information corresponding to the user, the application and the user device;
determining a pattern of activity for the user, the pattern of activity related to usage of the application; and
performing the analysis of the activity related to execution of the application based further on the pattern of activity.

8. The method of claim 1, further comprising the upgrade instance being provided by a Cloud.

9. A device comprising:
a processor configured to:
identify an application installed on a user device;
analyze activity related to execution of the application by a user;
determine, based on the analysis, an upgrade instance, the upgrade instance corresponding to the activity of the user;
communicate, via a user interface (UI) of a chatbot, with the user, the communication corresponding to the upgrade instance; and
perform the upgrade instance based on the communication with the user via the chatbot.

10. The device of claim 9, wherein the processor is further configured to:
analyze information related to the upgrade instance;
compile a prompt for the chatbot; and
output, via the UI, the prompt.

11. The device of claim 10, wherein the processor is further configured to:
receive feedback from the user via the UI in response to the prompt;
analyze the feedback; and
determine, based on the analysis of the feedback, whether to perform the upgrade instance.

12. The device of claim 10, further comprising the analysis of the information related to the upgrade instance being performed by a large language model (LLM) associated with the chatbot.

13. The device of claim 9, further comprising the activity related to the execution of the application corresponding to features of the application, the activity related to the usage of the features by the user.

14. The device of claim 9, further comprising the activity related to the execution of the application corresponding to a point of failure related to the usage of the application by the user, the point of failure related to non-used features or abandonment of use of the application by the user.

15. The device of claim 9, wherein the processor is further configured to:
analyze information associated with the user, the information corresponding to the user, the application and the user device;
determine a pattern of activity for the user, the pattern of activity related to usage of the application; and
perform the analysis of the activity related to execution of the application based further on the pattern of activity.

16. The device of claim 9, further comprising the upgrade instance being provided by a Cloud.

17. A non-transitory computer-readable storage medium tangibly encoded with computer-executable instructions that when executed by a device, perform a method comprising:
identifying an application installed on a user device;
analyzing activity related to execution of the application by a user;
determining, based on the analysis, an upgrade instance, the upgrade instance corresponding to the activity of the user;
communicating, via a user interface (UI) of a chatbot, with the user, the communication corresponding to the upgrade instance; and
performing the upgrade instance based on the communication with the user via the chatbot.

18. The non-transitory computer-readable storage medium of claim 17, further comprising:
analyzing information related to the upgrade instance;
compiling a prompt for the chatbot; and
outputting, via the UI, the prompt.

19. The non-transitory computer-readable storage medium of claim 18, further comprising:
receiving feedback from the user via the UI in response to the prompt;
analyzing the feedback; and
determining, based on the analysis of the feedback, whether to perform the upgrade instance.

20. The non-transitory computer-readable storage medium of claim 18, further comprising the analysis of the information related to the upgrade instance being performed by a large language model (LLM) associated with the chatbot.
